(19) United States
(12) Patent Application Publication
(10) Pub. No.: US 2020/0361428 A1
(43) Pub. Date: Nov. 19, 2020

(54) Brake System for a Motor Vehicle and Method for Operating a Brake System

(71) Applicant: Volkswagen Aktiengesellschaft, Wolfsburg (DE)

(72) Inventors: Marc Blumentritt, Braunschweig (DE); Christopher Protze, Wolfsburg (DE); Halit Alagöz, Hannover (DE)

(73) Assignee: Volkswagen Aktiengesellschaft, Wolfsburg (DE)

(21) Appl. No.: 16/753,918

(22) PCT Filed: Sep. 28, 2018
(86) PCT No.: PCT/EP2018/076382

§ 371 Date: Apr. 6, 2020

(30) Foreign Application Priority Data
Oct. 6, 2017 (DE) 10 2017 217 856.6

(51) Int. Cl. B60T 7/12; B60T 17/22; B60T 13/74; B60T 1/00

(52) U.S. Cl. CPC B60T 7/12; B60T 17/221; B60T 7/16; B60T 1/005; B60T 2250/04; B60T 13/74

(57) ABSTRACT

The invention relates to a brake system for a motor vehicle, a method for operating such a brake system, as well as a motor vehicle with such a brake system, wherein the brake system comprises a primary system and a secondary system that are each designed to automatically brake the motor vehicle to a standstill and then secure it at a standstill according to an emergency function. At least the primary system is designed to perform the emergency function when a fault occurs in a vehicle function designed to autonomously control or remotely control the motor vehicle. The secondary system is configured to perform the emergency function when an additional fault occurs in the primary system.

### CROSS-REFERENCE TO RELATED APPLICATIONS

This application claims priority to German Patent Application No. DE 10 2017 217 856.6 filed on Oct. 6, 2017 with the German Patent and Trademark Office. The contents of the aforesaid Patent Application are incorporated herein for all purposes.

### TECHNICAL FIELD

The invention relates to a brake system for a motor vehicle, a method for operating a brake system, as well as a motor vehicle with such a brake system.

### BACKGROUND

In many driver assist functions that are currently built in as standard in motor vehicles, the driver of the motor vehicle is included as the fallback level in the event of an emergency, such as when there is a technical defect in the driver assist function. This means that if a fault occurs during the operation of a driver assist function, a corresponding message is output to the driver, and driver must assume the task of the corresponding driver assist function.

However in the future with driver assist functions that are also designed to autonomously control or remotely control a motor vehicle, a driver of the motor vehicle will not always be able to be included as the fallback level since the driver for example will no longer be in the motor vehicle or can only intervene at a delay.

It is already known from DE 10 2014 221 007 A1 that an additional emergency target trajectory is determined in addition to a standard target trajectory in a driver assistance function serving as a traffic jam pilot. To accomplish this, two standard target trajectories are always ascertained by the traffic jam pilot based on the environmental data of a motor vehicle, these two target trajectories are compared with each other, and one of the two target trajectories are selected, on the basis of which the vehicle is driven at least semi-automatically. This procedure makes it possible to be able to access the unselected standard target trajectory in the event of a fault in one of the processing apparatuses of the traffic jam pilot, or in the event of a fault in a component of the motor vehicle, and to continue driving the motor vehicle using this emergency target trajectory.

With many driver assist functions that enable at least partially automated driving of the motor vehicle, it is however less important in an emergency for the driver assist function or another control unit of the motor vehicle to be provided with an emergency plan according to which the motor vehicle is still steered. Instead, it is a priority to define a system and a procedure by means of which autonomously controlled motor vehicles can be braked to a standstill as quickly as possible in an emergency, and possibly taking into account a current traffic situation, and then secured in a standstill.

### SUMMARY

An object of the invention is to provide a system for a motor vehicle by means of which operating the motor vehicle with an autonomous or remote controlled vehicle function can be designed particularly safe.

This object is solved by a brake system, a vehicle with a brake system, as well as a method of operating a brake system according to the independent claims. Embodiments of the invention are the discussed in the dependent claims and the following description.

### BRIEF DESCRIPTION OF THE DRAWINGS

IN THE FIGS.:

FIG. 1 shows a schematic representation of a brake system of a motor vehicle at a motor vehicle speed below a predefined speed;

FIG. 2 shows a schematic representation of system states of a primary system of the brake system;

FIG. 3 shows a schematic representation of the system states of a secondary system of the brake system;

FIG. 4 shows a schematic representation of the brake system at a motor vehicle speed greater than or equal to the predefined speed.

### DETAILED DESCRIPTION

According to one exemplary aspect of the invention, the object is achieved by a brake system for a motor vehicle that comprises a primary system and a secondary system that is designed to automatically brake the motor vehicle to a standstill and then secure the motor vehicle in a standstill according to an emergency function, wherein at least the primary system is designed to perform the emergency function when a fault occurs in a vehicle function designed to autonomously control or remotely control the motor vehicle, wherein the secondary system is designed in this case to perform the emergency function when a fault occurs in the primary system. The brake system proposed according to the present aspect is therefore a brake system that consists of two partial brake systems. Both partial brake systems, i.e., both the main brake system termed the primary system as well as the auxiliary brake system termed the secondary system are designed to stop a motor vehicle corresponding to a specified braking routine and secure it against rolling.

Moreover, the primary system is capable of performing the specified braking routine if a fault occurs in a vehicle function. The vehicle function in this case is a driver assist function with which it is possible to independently or remotely control the motor vehicle. It is moreover provided that the brake system is designed so that the secondary system brings the motor vehicle to a standstill and keeps it at a standstill using its specified braking routine in the event of a fault of the vehicle function as well as when a fault additionally occurs in the primary system.

This redundant brake system can for example be used in combination with a vehicle function such as for example a park assist, or an adaptive cruise control system. If for example independent parking of a motor vehicle without a driver on board is desired according to a customer function, the brake system makes it possible for the motor vehicle to be braked by the primary system and secured at a standstill upon a failure of the corresponding vehicle function, for example when the radio contact between the remote control unit of the driver and the control apparatuses for the vehicle function fails. In the event of an additional technical failure in the primary system, the vehicle can also be stopped by the secondary system, i.e., using the specified braking routine of the secondary system.

In an embodiment, the emergency function provides engaging in emergency braking and then securing the motor vehicle at a standstill at a motor vehicle speed below a predefined speed. If the motor vehicle is therefore driving more slowly than a certain maximum speed and at least one of the cited conditions for braking and then securing the motor vehicle at a standstill is fulfilled, it is provided according to the specified braking routine for the motor vehicle to be braked to a standstill and then secured against rolling. If for example the motor vehicle is in a parking process that is being performed with the assistance of a remote-controlled park assist, abrupt braking of the motor vehicle can be carried out according to the specified braking routine. The emergency braking performed according to the emergency function is similar to a type of emergency stop of the motor vehicle. Such an emergency stop function is particularly beneficial when the vehicle is being parked remotely controlled by a vehicle function, i.e., the vehicle driver himself cannot brake the vehicle even in an emergency, or when the vehicle is being driven by a vehicle function in a play street in which stopping the motor vehicle as quickly as possible without delayed engagement by the driver is desirable. The speed range in which this emergency stop function is provided lies within the maneuvering range of the motor vehicle, i.e., at speeds up to, e.g., 15 km/h.

Another embodiment of the brake system provides that the emergency function brakes the motor vehicle to a standstill and then secures it at a standstill taking into account a current traffic situation at a motor vehicle speed greater than or equal to the predefined speed. As of a certain maximum speed, it is therefore provided that the current traffic situation is taken into account using the specified braking routine, and the motor vehicle adapted to this traffic situation is braked and then secured against rolling. If the vehicle for example is being guided fully autonomously on a highway by a vehicle function, sudden emergency braking of the vehicle therefore does not occur when the emergency function is activated; instead, a braking process occurs adapted to the current speed and the current traffic volume. In this case, the braking routine could specify the time and distance in which the motor vehicle is braked at a certain speed until it comes to a standstill. To determine the emergency function, information from different sensors such as from outside cameras of the motor vehicle can be used for this, by means of which the current traffic situation can be monitored. It is also possible for the emergency function to be determined taking into account data from car-to-car communication, or car-to-X communication. At higher vehicle speeds, i.e., typically starting at speeds of for example 15 km/h, it is provided to brake the motor vehicle according to a specified emergency and then secure it at a standstill in case the vehicle function or the primary system malfunctions. Given such a braking of the motor vehicle adapted to the current traffic situation, the probability of secondary accidents, for example from rear-end collisions with other road users, can be reduced in comparison to an emergency stop procedure.

Another embodiment provides that the primary system and the secondary system are designed to execute at least one subfunction of the vehicle function while the emergency function is being performed. When activating one of the two partial brake systems, a task of the vehicle function continues to be performed in addition to the specified braking routine. If for example one subfunction of the vehicle function is a function that controls braking of the motor vehicle, this function can also be performed by the primary or secondary system. If however the primary and/or secondary system is a brake system that for example can also affect the steering of the motor vehicle or can influence the speed of the motor vehicle, the emergency function can also be an emergency trajectory. In this case, the vehicle function can send continuously updated trajectories to the primary and secondary system with which the motor vehicle could be steered and braked in the event of a fault of the vehicle function. Since the primary and secondary system can assume subfunctions of the vehicle function, they constitute a supplement to the vehicle function which is particularly beneficial in an emergency for the motor vehicle to safely stop.

Another embodiment of the brake system provides that the secondary system is designed to perform the emergency function already in the event of a fault in the primary system, even if a fault has not occurred in the vehicle function. The secondary system is therefore capable of stopping the motor vehicle using the specified braking routine for the secondary system and then securing against rolling in the event of a defect in the primary system when the vehicle function is functioning error-free, i.e., in the event of error-free functioning of an activated driver assist function. If for example the motor vehicle is being moved slowly in a parking garage by means of a remote-controlled park assist and a failure of the primary system unexpectedly occurs, the immediate emergency stop of the vehicle is executed by the secondary system. This allows the motor vehicle to be driven very safely, in particular in situations in which a vehicle function controls the motor vehicle remotely without the driver being in the motor vehicle. If in contrast the motor vehicle is autonomously controlled for example on a multilane freeway with an adaptive cruise control at speeds above the predefined speed, the emergency function adapted to the current traffic situation available to the secondary system is performed in the event of a defect in the primary system, and the vehicle is therefore also braked, although at a delay, and secured at a standstill.

Another embodiment provides that the primary system is designed to perform the emergency function already in the event of a fault in the secondary system, even though no fault has occurred in the vehicle function. It is therefore provided that when the vehicle function is functioning error-free, the main brake system already activates its specified brake routine only if a defect in the auxiliary brake system is reported. If for example the vehicle function is a park assist that is used by remote control in a parking garage, the motor vehicle is immediately stopped with the assistance of the emergency stop function in the event of the failure of the secondary system, even if the primary system, and the vehicle function as well, continue to function error-free. This enables additional safeguarding when driving with a vehicle function for autonomously controlling, or for remotely controlling, the motor vehicle since it is accordingly a requirement for operating the corresponding vehicle function that two systems be available for braking and securing the motor vehicle in a standstill.

In another embodiment, the primary system is designed to control all means designed for braking and/or securing the vehicle in a standstill. It is accordingly provided for the control of the primary system to be able to access all actuators of brakes or retaining mechanisms of the vehicle, to access both their control as well as their triggering mechanisms. Even in an error-free state, a function software of the primary system which is for example the function program for controlling driving dynamics (ESC, electronic stability control) can therefore actuate all other vehicle components provided for braking or securing the motor vehicle. These other components may for example be an electric parking brake (EPB), an electric brake booster (EBB), or a parking lock. In the case of an individual fault, for example in the event of a failure of a corresponding communication bus, the primary system can still access individual, nondefective vehicle components provided for braking or securing the motor vehicle of the two partial brake systems. If for example the retaining mechanism of the primary system is defective, the primary system could secure the motor vehicle in a standstill with the assistance of the retaining mechanism of the secondary system after the motor vehicle has been braked. This enables prioritized controlling of the brake system by the control of the primary system, which enables a particularly fast reaction by the brake system in an emergency.

Another embodiment provides that the secondary system is designed to brake the vehicle by actuating an electric brake booster of the vehicle. If the vehicle is braked by the secondary system, this is carried out with the assistance of an electric brake booster (EBB). In addition to an electric brake booster as an actuator of the brake, an electric parking brake (EPB) or another brake is conceivable.

Another embodiment provides that the secondary system is designed to secure the vehicle at a standstill by actuating a parking lock.

It is therefore provided that the secondary system uses a transmission lock to secure the motor vehicle at a standstill. However, an electric parking brake (EPB) or another emergency brake would however be suitable as a retaining mechanism. With this retaining mechanism, it can be achieved that the motor vehicle, after it has been braked, is held securely at a standstill and secured against potential rolling.

In a further embodiment of the brake system it is provided that the primary and/or secondary system is designed to perform the emergency function when at least one of the following faults in the vehicle function occurs: Fault in communication with the vehicle function, exceeding a limit value of the vehicle speed specified by the vehicle function, and request by the vehicle function to perform the emergency function. The primary and/or secondary system would then start braking the motor vehicle according to its specified brake routine when one of the following defects in the functioning of the activated vehicle function is observed. On the one hand, these defects can be problems with the exchange of data between the primary and/or secondary system and the vehicle function. On the other hand, the emergency function can be triggered when it is established that the current vehicle speed lies above a maximum speed specified by the vehicle function, or the emergency function is called by the vehicle function.

A fault in communication with the vehicle function results for example when a corresponding communication bus fails, or other parts of the control of the primary and/or secondary system or the vehicle function fail. A deviation from a limit value specified by the vehicle function results, for example, when the vehicle function is a park assist that has the instruction to only perform a parking process within a certain speed range, for example between 0 km/h and 10 km/h. If it is established that the speed value is exceeded, for example due to an error in the speed control, an emergency stop is initiated by the primary or secondary system because of this deviation from the specified maximum speed of the motor vehicle by the park assist. In another scenario, an active vehicle function requests the primary and/or secondary system to perform the emergency function. For example it is provided in many remote-controlled park assists for the vehicle to only be automatically driven when a button is pressed on a vehicle key or in a smart phone app linked to the vehicle function. Once this activation element is no longer pressed, the corresponding signal is forwarded to the primary system and the emergency function of the primary system is activated, i.e., an emergency stop of the motor vehicle is performed. Since a communication fault with the primary and/or secondary system, and/or a deviation from a specified limit value of the vehicle function, occurs with any type of technical defect in the vehicle function, in the event of a failure of the vehicle function, the vehicle is reliably stopped and secured at a standstill with the assistance of the primary and/or secondary system corresponding to the provided emergency function.

Another embodiment provides that the primary and secondary system are designed to perform the emergency function when at least one of the following faults occurs in the respective systems: Fault in communication between the primary and secondary system, defect of the primary system, and defect of the secondary system. The primary or secondary system accordingly initiates its specified braking routine for braking the motor vehicle and securing the motor vehicle at a standstill when one of the following defects is established in the primary and the secondary system: The emergency function is activated when problems occur in the exchange of data between the primary and secondary system, a system component of the primary system fails, or a system component of the secondary system fails. Communication problems between the primary and secondary system result for example in the event of failures of functions of the respective control software, or they can arise from technical defects in the control of the two partial brake systems, or from problems in the communication path such as for example a short circuit on the communication bus. Defects in the primary or secondary system result for example from technical problems and faults in the corresponding brakes and retaining mechanisms. If the failure of one of the two partial brake systems is accordingly established, braking and securing the motor vehicle with the other partial brake system is initiated to prevent the motor vehicle from driving autonomously or remotely controlled with only one available brake system. This serves as an additional safeguard in autonomous and remotely-controlled operation of the motor vehicle.

The motor vehicle according to another aspect comprises the brake system explained above or a embodiment of the brake system.

In the method for operating the brake system according to yet another aspect or a embodiment of the brake system, the primary system performs the emergency function if a fault occurs in a vehicle function designed to autonomously control and remotely control the motor vehicle, wherein in contrast, the secondary system performs the emergency function instead in the event that a fault arises in the primary system. The brake system is therefore operated such that in the event of a malfunction of a vehicle function such as a vehicle assistance function that enables independent driving of the motor vehicle controlled by a remote control, the primary system brakes the motor vehicle according to its specified braking routine and keeps it at a standstill, wherein the secondary system in this case activates its specified braking routine and accordingly takes over braking the motor vehicle and then securing it at a standstill should the primary system be defective.

Also belonging to the present aspect are embodiments of the method that have features which have been described in conjunction with the brake system of the method according to the first aspect. For this reason, the corresponding embodiments will not again be described.

In the following, two additional exemplary embodiments are described.

In the exemplary embodiments, the described components of the embodiments each represent individual features of the invention that should be considered independent of each other, and each also develop the invention independently from each other and should therefore be considered as a part of the invention both individually or in another combination other than that shown. In addition, the described embodiments can also be supplemented by other features or embodiments of the invention than those already described.

Elements having the same functions are, in each case, provided with the same reference numerals in the FIGS.

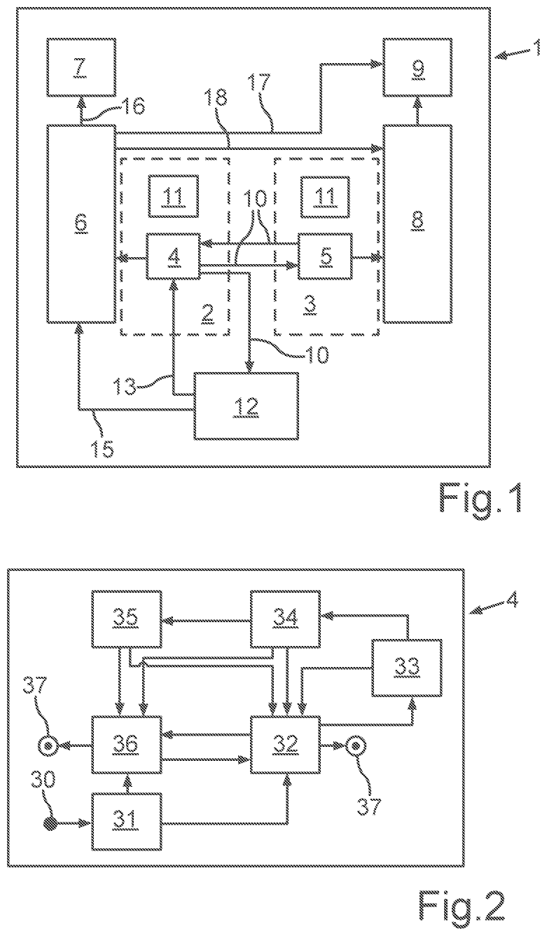

FIG. 1 shows a brake system 1 for a motor vehicle. The brake system 1 has a primary system 2 and a secondary system 3. A control 4 of the primary system 2 that is for example a driving dynamics control system actuates a brake actuation system 6 of the driving dynamics control system and a retaining mechanism that can be an electric parking brake 7. Analogously, a control 5 of the secondary system 3 can actuate another brake actuation system that is for example an electric brake booster 8. A parking lock 9 can be provided for example as a retaining mechanism actuated by the control 5 of the secondary system 3. The controls 4 and 5 of the primary and secondary system 2 and 3, that can also be termed their state machines, exchange state messages with each other. This data exchange is represented using two arrows 10.

The extent to which the controls 4 and 5 of the primary and secondary system 2 and 3 function flawlessly is initially monitored by respective monitoring units 11. If these monitoring units detect a fault, for example from a defective microcontroller, this fault is forwarded to an emergency control software of the respective subsystem and can lead to the triggering of an emergency function. According to the instructions of the emergency function, the motor vehicle is braked to a standstill and then secured in a standstill.

The control 4 of the primary system 2 moreover exchanges data with a vehicle function 12 that, as a customer function, performs a task requested by a user of the motor vehicle such as for example parking the motor vehicle in a parking garage by remote control. If an emergency stop of the motor vehicle is desired by the vehicle function 12, a corresponding data signal 13 is sent by the vehicle function 12 to the control 4 of the primary system 2. Moreover, the control 4 of the primary system 2 transmits its state data 10 to the vehicle function 12. In addition, the vehicle function 12 transmits a normal function 15 of the vehicle function 12 to the driving dynamics control system 6. This normal function 15 can be for example a target speed or a maximum or minimum speed of the vehicle.

It is moreover provided that the primary system 2, with the assistance of its control 4, can actuate not just the electric parking brake 7 via the brake actuation system 6, but also the electric brake booster 8 and the parking lock 9. To accomplish this, corresponding actuation signals 16, 17 and 18 can be sent via the brake actuation system 6 of the driving dynamics control system to the corresponding retaining mechanisms, the electric brake booster 8 and the parking lock 9, and to the electric parking brake 7.

With the brake system 1 as shown in FIG. 1, emergency braking of the motor vehicle and subsequent securing of the motor vehicle at a standstill is performed according to an emergency function when a motor vehicle speed lies below a predefined speed that is typically 15 km/h, controlled by the controls 4 or 5 of the primary or secondary system 2 and 3, or by the vehicle function 12. An emergency stop brake system is accordingly sketched in FIG. 1.

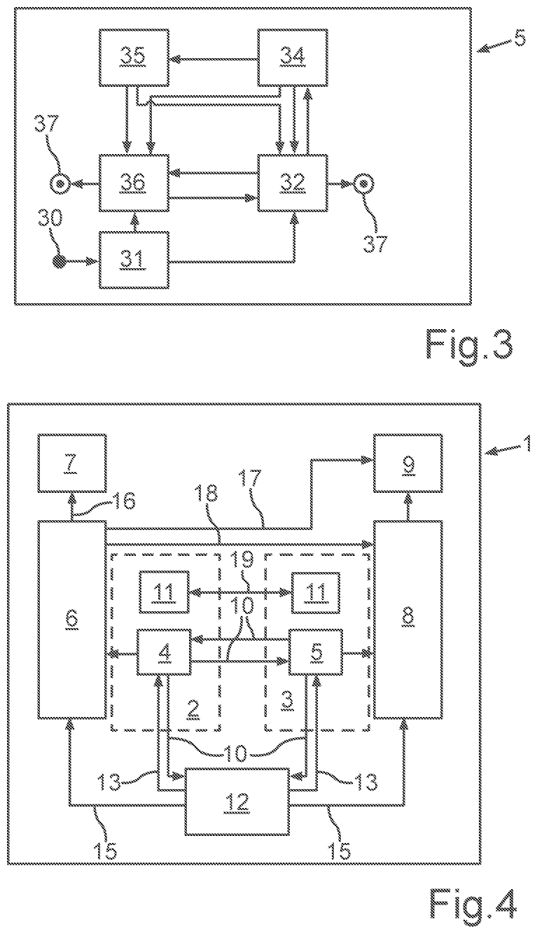

The individual states of the control 4 of the primary system 2 are portrayed in FIG. 2 relating to operating the brake system 1 as an emergency stop brake system, i.e., motor vehicle speeds below the predefined speed. The control 4 of the primary system 2 can assume six different states in this case, between which state messages, data or signals are transmitted according to the drawn arrows. After a function start 30 of the motor vehicle, the control 4 of the primary system 2 is initialized and transitions into the “initialization” state 31. If all of the system components of the primary system 2 are available error-free, and the control 5 of the secondary system 3 reports to the control 4 of the primary system 2 that it is in the “available” state 32 (see FIG. 3 for the states of the control 5 of the secondary system 3), the control 4 of the primary system 2 switches from the “initialization” state 31 to be “available” state 32.

If a vehicle function 12 is then activated that requests a monitoring of its function by the brake system 1, the control 4 of the primary system 2 switches from the “available” state 32 to the “request secondary system” state 33 if the state message of the control 5 of the secondary system 3 is still sending the “available” state 32 to the control 4 of the primary system 2, and the current speed of the motor vehicle lies below a target speed specified by the vehicle function 12. Then the control 4 of the primary system 2 switches its state from “request secondary system” 33 to the “passive monitoring” state 34 once the control 5 of the secondary system 3 reports that it is in the “passive monitoring” state 34. The “passive monitoring” state 34 corresponds to the normal state of the control 4 of the primary system 2.

In the event of error-free functioning of the vehicle function 12, the system switches from the “passive monitoring” state 34 to the “available” state 32 once the vehicle function 12 is terminated. For example, if the vehicle function 12 is a park assist, the system state of the control 4 of the primary system 2 would switch back to “available” 32 once the parking process is over.

The state of the control 4 of the primary system 2 switches from the “passive monitoring” state 34 to the “actively triggered” state 35 when signals are transmitted that indicate a fault in the secondary system 3, such as that the control 5 of the secondary system 3 is leaving the “passive monitoring” state 34, or if a communication fault occurs in the data exchange with the control 5 of the secondary system 3, communication problems occur between the control 4 of the primary system 2 and the vehicle function 12, exceeding the target speed value transmitted by the vehicle function 12 is established, or the vehicle function 12 requests an emergency stop by the control 4 of the primary system 2.

In the “actively triggered” state 35, the vehicle is slowed down to a standstill and secured in a standstill. Once the vehicle is in a standstill, the control 4 of the primary system 2 can switch back to the “available” state 32 as long as there is no technical defect. If the vehicle is however still in a standstill and it was additionally established that either the control 5 of the secondary system 3 has reported a “defective system component” state 36, a communication fault with the control 5 of the secondary system 3 exists, or it was established that at least one component of the primary system 2 and/or the brake actuation system 6 of the driving dynamics control system and/or the electric parking brake 7 are defective, the control 4 of the primary system 2 switches its state from “actively triggered” 35 to “defective system component” 36. In the event of one of the aforementioned defects or faults, the control 4 of the primary system 2 can also immediately switch from the “passive monitoring” state 34 to the “defective system component” state 36.

Once all of the components of the primary system 2 as well as the brake actuation system 6 of the driving dynamics control system and the electric parking brake 7 are again functional and the control 5 of the secondary system 3 reports the “available” state 32, the control 4 of the primary system 2 switches from the “defective system component” state 36 back to the “available” state 32. If, in the “available” state 32, the control 4 of the primary system 2 recognizes that the control 5 of the secondary system 3 is in the “defective system component” state, or a communication fault with the control 5 of the secondary system 3 has occurred, the system switches directly from the “available” state 32 to the “defective system component” state 36. It is possible to terminate the control 4 of the primary system 2 both in the “available” state 32 as well as in the “defective system component” state 36. Such a function termination 37 occurs for example by switching off the motor vehicle.

It is moreover provided that the control 4 of the primary system switches back to the “available” system state 32 from the “request secondary system” state 33, either directly by terminating the vehicle function 12, or after a prescribed maximum duration in the event of no response from the control 5 of the secondary system 3, for example if a corresponding fault occurs in the communication between the controls 4 and 5 of the primary and secondary system 2 and 3.

The five different states of the control 5 of the secondary system 3 are portrayed in FIG. 3. State messages, data and signals are transmitted between these states corresponding to the drawn arrows. The control 5 of the secondary system 3 switches from the “initialization” state 31 to the “available” state 32 once it is reported that all of the components of the secondary system 3 as well as the electric brake booster 8 and the parking lock 9 are functioning error-free. Once the control 5 of the secondary system 3 is in the “available” state 32 and is queried by the control 4 of the primary system 2, the control 5 of the secondary system 3 switches from the “available” state 32 to the “passive monitoring” state 34.

The control 5 of the secondary system 3 switches back from the “passive monitoring” state 34 to the “available” state 32 when the control 4 of the primary system 2 switches to the “available” state 32. If however the control 4 of the primary system 2 reports that it is in the “defective system component” state 36, or a communication fault with the control 4 of the primary system 2 is established, the control 5 of the secondary system 3 switches from the “passive monitoring” state 34 to the “actively triggered” state 35.

In the “actively triggered” state, the vehicle is braked to a standstill and secured at a standstill. The control 5 of the secondary system 3 can switch from the “actively triggered” state 35 back to the “available” state 32 once the motor vehicle is at a standstill. If the secondary system 3 itself does not have any sensors with which it can be determined if the motor vehicle is at a standstill, a maximum delay, i.e., a maximum duration of braking, can be stipulated after which the control 5 of the secondary system switches from the “actively triggered” state 35 back to the “available” state 32.

In the event of a defect of a component of the secondary system 3 and/or the electric brake booster 8 and/or the parking lock 9, the control 5 of the secondary system 3 can either switch directly from the “passive monitoring” state to the “defective system component” state 36, or can switch from the “actively triggered” state 35 to the “defective system component” state 36. Once all of the components of the secondary system 3 as well as the electric brake booster 8 and the parking lock 9 again function error-free, i.e., are available, the system state again switches from “defective system component” 36 to “available” 32. If in the “available” state 32 the control 5 establishes that a component of the secondary system 3, and/or the electric brake booster 8, and/or the parking lock 9 are defective, the control 5 of the secondary system 3 switches directly from the “available” state 32 to the “defective system component” state 36.

Analogous to the control 4 of the primary system 2, it is also provided in the control 5 of the secondary system 3 that a function start 30 activates the function, for example by starting the engine, and that this can be terminated by switching from the “available” system state 32 or “defective system component” 36 state to function termination 37.

FIG. 4 again sketches the brake system 1, however in comparison to FIG. 1, all data and signal paths are also drawn that are activated at a motor vehicle speed greater than or equal to the predefined speed. At speeds typically starting at 15 km/h, braking the motor vehicle to a standstill taking into account a current traffic situation and then securing the motor vehicle at a standstill are provided according to the emergency function transmitted by the vehicle function 12. An emergency brake system is therefore sketched in FIG. 4.

This emergency brake system differs from the emergency stop brake system sketched in FIG. 1 in that the vehicle function 12 not only exchanges state messages, data and signals with the control 4 of the primary system 2, but also with the control 5 of the secondary system 3. According to the emergency brake system, the vehicle function 12 determines the emergency functions for the primary and secondary system 2 and 3 according to which the vehicle is braked depending on the current traffic situation and is then secured at a standstill. These emergency functions are transmitted both to the control 4 of the primary system 2 as well as to the control 5 of the secondary system 3 which is shown by the arrows 13. The vehicle function 12 receives both the state message of the control 4 of the primary system 2 (see the corresponding arrow 10) as well as the state message of the control 5 of the secondary system 3 (see the corresponding arrow 10). The normal function 15 specified by the vehicle function 12 can be for example a target speed or a maximum or minimum speed of the vehicle, and is transmitted according to the emergency brake system both to the brake actuation system 6 of the driving dynamics control system (see the corresponding arrow 15), as well as to the electric brake booster 8 that is actuated by the control 5 of the secondary system 3 (see the corresponding arrow 15).

If a fault of the vehicle function 12 occurs, the control 4 of the primary system 2 instigates the braking of the motor vehicle with the assistance of the brake actuator system 6 of the driving dynamics control system based on the emergency function last transmitted by the vehicle function 12. If a fault occurs in the primary system 2 in addition to a fault in the vehicle function 12, for example in its control 4, and/or the brake actuation system 6 of the driving dynamics control system, and/or the electric parking brake 7, the motor vehicle can be braked by the electric brake booster 8 controlled by the control 5 of the secondary system 3 based on the emergency function transmitted to the control 5 of the secondary system 3.

According to the emergency brake system, it is moreover provided that the monitoring units 11 of the primary and secondary system 2 and 3 each exchange their system status 19 via a communication link. Since the vehicle function 12 is in contact with both the control 4 of the primary system 2 as well as with the control 5 of the secondary system 3, the vehicle function 12 can continue to exchange data with the error-free partial brake system in the event of a fault in one of the two partial brake systems, such as still transmit continuously updated emergency functions to the control 4 or 5 of the respective partial brake system 2 and 3.

The braking and subsequent securing of the motor vehicle at a standstill has been described using the example of a brake actuation system 6 controlled by a driving dynamics control system, an electric brake booster 8, an electric parking brake 7 and a parking lock 9, wherein this is one of numerous optional embodiments.

### LIST OF REFERENCE NUMBERS

1 Brake system

2 Primary system

3 Secondary system

4 Control

5 Control

6 Brake actuation system

7 Electric parking brake

8 Electric brake booster

9 Parking lock

10 State message

11 Monitoring unit

12 Vehicle function

13 State message

15 Normal function

16 Control signal

17 Control signal

18 Control signal

19 System status

30 Function start

31 “Initialization” state

32 “Available” state

33 “Request secondary system” state

34 “Passive monitoring” state

35 “Actively triggered” state

36 “Defective system component” state

37 Function termination

The invention has been described in the preceding using various exemplary embodiments. Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor, module or other unit or device may fulfill the functions of several items recited in the claims.

The mere fact that certain measures are recited in mutually different dependent claims or embodiments does not indicate that a combination of these measures cannot be used to advantage. Any reference signs in the claims should not be construed as limiting the scope.

What is claimed is:

1. A brake system for a motor vehicle comprising:
A primary system and a secondary system that are each configured to automatically brake the motor vehicle to a standstill and then secure it at a standstill according to an emergency function;
wherein at least the primary system is configured to perform the emergency function when a fault occurs in a vehicle function designed to autonomously control or remotely control the motor vehicle, wherein the secondary system is configured in this case to perform the emergency function when a fault occurs in the primary system.

2. The brake system of claim 1, wherein the emergency function provides engaging in emergency braking and then securing the motor vehicle in a standstill at a motor vehicle speed below a predefined speed.

3. The brake system of claim 2, wherein at a motor vehicle speed greater than or equal to the predefined speed, the emergency function provides braking the motor vehicle to a standstill and then securing it at a standstill taking into account a current traffic situation.

4. The brake system of claim 3, wherein the primary system and the secondary system are configured to execute at least one subfunction of the vehicle function while performing the emergency function.

5. The brake system of claim 1, wherein the secondary system is configured to perform the emergency function already in the event of a fault in the primary system even if a fault has not occurred in the vehicle function.

6. The brake system of claim 1, wherein the primary system is configured to perform the emergency function already in the event of a fault in the secondary system, even though no fault has occurred in the vehicle function.

7. The brake system of claim 1, wherein the primary system is configured to control all means configured for braking and/or securing the vehicle in a standstill.

8. The brake system of claim 1, wherein the secondary system is configured to brake the vehicle by actuating an electronic brake booster.

9. The brake system of claim 1, wherein the secondary system is configured to secure the vehicle at a standstill by actuating a parking lock.

10. The brake system of claim 1, wherein the primary and/or secondary system is configured to perform the emergency function when at least one of the following faults in the vehicle function occurs:
fault in communication with the vehicle function;
exceeding a limit value of the vehicle speed specified by the vehicle function;
request by the vehicle function to perform the emergency function.

11. The brake system of claim 1, wherein the primary and secondary system are configured to perform the emergency function when at least one of the following faults occurs in the respective systems:
fault in communication between the primary and secondary system;
defect of the primary system;
defect of the secondary system.

12. A motor vehicle with a brake system of claim 1.

13. Method for operating a brake system of claim 1, wherein the primary system performs the emergency function when a fault occurs in a vehicle function configured to autonomously control or remotely control the motor vehicle, wherein the secondary system contrastingly performs the emergency function in the event that a fault occurs in the primary system.

14. The brake system of claim 2, wherein the secondary system is configured to perform the emergency function already in the event of a fault in the primary system even if a fault has not occurred in the vehicle function.

15. The brake system of claim 3, wherein the secondary system is configured to perform the emergency function already in the event of a fault in the primary system even if a fault has not occurred in the vehicle function.

16. The brake system of claim 4, wherein the secondary system is configured to perform the emergency function already in the event of a fault in the primary system even if a fault has not occurred in the vehicle function.

17. The brake system of claim 2, wherein the primary system is configured to perform the emergency function already in the event of a fault in the secondary system, even though no fault has occurred in the vehicle function.

18. The brake system of claim 3, wherein the primary system is configured to perform the emergency function already in the event of a fault in the secondary system, even though no fault has occurred in the vehicle function.

19. The brake system of claim 4, wherein the primary system is configured to perform the emergency function already in the event of a fault in the secondary system, even though no fault has occurred in the vehicle function.

20. The brake system of claim 5, wherein the primary system is configured to perform the emergency function already in the event of a fault in the secondary system, even though no fault has occurred in the vehicle function.
